(19) United States
(12) Patent Application Publication
(10) Pub. No.: US 2024/0326389 A1
(43) Pub. Date: Oct. 3, 2024

(54) HEAT SHRINKABLE FILM AND MANUFACTURING METHOD THEREOF

(71) Applicant: GUNZE LIMITED, Kyoto (JP)

(72) Inventors: Tatsuya KIBAYASHI, Shiga (JP); Tsukasa NAKAO, Shiga (JP)

(73) Assignee: GUNZE LIMITED, Kyoto (JP)

(21) Appl. No.: 18/294,002

(22) PCT Filed: Aug. 3, 2022
(86) PCT No.: PCT/JP2022/029832

§ 371 Date: Jan. 31, 2024

(30) Foreign Application Priority Data
Aug. 5, 2021 (JP) 2021-128995

(51) Int. Cl. B32B 27/08; B29B 17/02; B29C 48/00; B29C 48/08; B29C 48/21; B29K 21/00; B29K 23/00; B29K 25/00; B29K 67/00; B32B 27/30; B32B 27/32; B32B 27/36

(52) U.S. Cl. CPC B32B 27/08; B29B 17/02; B32B 27/302; B32B 27/32; B32B 27/36; B29C 48/022; B29C 48/08; B29C 48/21; B29K 2021/003; B29K 2023/06; B29K 2023/12; B29K 2023/38; B29K 2025/06; B29K 2067/00; B29K 2995/0049; B32B 2250/03; B32B 2250/24; B32B 2250/40; B32B 2270/00; B32B 2272/00; B32B 2307/736

(57) ABSTRACT

A heat shrinkable film manufacturing method includes: preparing packaging materials including film labels having resin layers mainly including thermoplastic resin and print layers; preparing first and second virgin raw materials of thermoplastic resin; recovering, from the resin layers, a recycled raw material of thermoplastic resin; and forming a resin-based film including the recycled raw material as a raw material so as to have a core layer and a surface layer layered on the core layer wherein the forming the resin film includes at least one of: forming the core layer including at least the recycled raw material and the first virgin raw material and the surface layer mainly including the second virgin raw material; and forming the core layer including the first virgin raw material and the surface layer including the second virgin raw material and at most 25 wt % of the recycled material.

### FIELD OF INVENTION

The present invention relates to a heat shrinkable film and a manufacturing method thereof.

### BACKGROUND

Patent Literature 1 discloses a heat shrinkable film manufacturing method using recycled raw materials. Heat shrinkable films manufactured by this manufacturing method include virgin raw materials and recycled raw materials. In these heat shrinkable films, to suppress deterioration of various physical properties such as optical properties, the same raw materials, for example, raw materials mainly including polyester resin, are used as the virgin raw materials and the recycled raw materials.

### CITATION LIST

### Patent Literature

Japanese Patent Laid-Open Publication No. H6-047810

### SUMMARY OF INVENTION

### Technical Problem

An object of the present invention is to provide high-quality heat shrinkable films using a recycled raw material and provide a manufacturing method thereof.

### Solution to Problem

A manufacturing method for a heat shrinkable film according to a first aspect of the present invention includes the followings:

preparing packaging materials including a plurality of film labels having a resin layer including thermoplastic resin as a main component and a print layer:

preparing a first virgin raw material of thermoplastic resin and a second virgin raw material of thermoplastic resin that is different from the first virgin raw material: recovering, from the resin layer, a recycled raw material of one or more thermoplastic resins; and forming a resin-based film including the recycled raw material as a raw material so as to have a core layer and a surface layer layered on the core layer.

The recovering the recycled raw material of one or more thermoplastic resins includes: cutting at least either the packaging materials or the resin layer from which the print layer has been removed into pieces; and separating the print layer from at least either the packaging materials or the pieces of the packaging materials, thereby obtaining at least either the resin layer from which the print layer has been removed or the pieces of the resin layer from which the print layer has been removed.

The forming the resin-based film includes at least one of: forming the core layer including at least the recycled raw material and the first virgin raw material and the surface layer including the second virgin raw material as a main component, and forming the core layer including at least the first virgin raw material and the surface layer including the second virgin raw material and the recycled raw material of 25 wt % (percentage by weight) or less.

A manufacturing method for a heat shrinkable film according to a second aspect of the present invention is the manufacturing method for a heat shrinkable film according to the first aspect, wherein the forming the resin-based film includes forming the core layer including at least the recycled raw material and the first virgin raw material and the surface layer mainly including the second virgin raw material, and the recycled raw material include a first recycled raw material of a first thermoplastic resin and a second recycled raw material of a second thermoplastic resin that is different from the first thermoplastic resin.

A manufacturing method for a heat shrinkable film according to a third aspect of the present invention is the manufacturing method for a heat shrinkable film according to the first or second aspect, wherein the first virgin raw material is a virgin raw material of the first thermoplastic resin.

A heat shrinkable film according to a fourth aspect of the present invention is the manufacturing method for a heat shrinkable film according to any one of the first to third aspects, wherein the forming the resin-based film includes forming the core layer such that a proportion of the second recycled raw material to the recycled raw material in the core layer is equal to or less than 25 wt %.

A heat shrinkable film according to a fifth aspect of the present invention is the manufacturing method for a heat shrinkable film according to any one of the first to fourth aspects, wherein the forming the resin-based film includes forming the core layer such that a proportion of the recycled raw material in the core layer is not less than 2.5 wt % and not greater than 80 wt %.

A heat shrinkable film according to a sixth aspect of the present invention is the manufacturing method for a heat shrinkable film according to any one of the first to fifth aspects, wherein the first thermoplastic resin is polystyrene-based resin and the second thermoplastic resin is polyester-based resin.

A heat shrinkable film according to a seventh aspect of the present invention is the manufacturing method for a heat shrinkable film according to any one of the first to sixth aspects, wherein the first thermoplastic resin is polypropylene-based resin and petroleum-based resin, and the second thermoplastic resin is polyethylene-based resin and cyclic olefin-based resin.

A heat shrinkable film according to an eighth aspect of the present invention is the manufacturing method for a heat shrinkable film according to any one of the first to seventh aspects, wherein the forming the resin-based film includes forming the core layer including at least the first virgin raw material and the surface layer including the second virgin raw material and the recycled raw material of 25 wt % or less, and the recycled raw material includes a third recycled raw material of a third thermoplastic resin and a fourth recycled raw material of a fourth thermoplastic resin that is different from the third thermoplastic resin.

A heat shrinkable film according to a ninth aspect of the present invention is the manufacturing method for a heat shrinkable film according to any one of the first to eighth aspects, wherein the second virgin raw material is a virgin raw material of the third thermoplastic resin.

A heat shrinkable film according to a tenth aspect of the present invention is the manufacturing method for a heat shrinkable film according to any one of the first to ninth aspects, wherein the forming the resin-based film includes forming the surface layer such that a proportion of the fourth recycled raw material to the recycled raw material in the surface layer is equal to or less than 15 wt %.

A heat shrinkable film according to an eleventh aspect of the present invention includes: a core layer including a virgin raw material and a recycled raw material; and a surface layer layered on at least one surface of the core layer and configured solely by a virgin raw material that is substantially different from the virgin raw material for the core layer.

According to the above-described heat shrinkable film, since the surface of the core layer including the recycled raw material is covered with the surface layer substantially configured solely by the virgin raw material, optical properties and the like are unlikely to deteriorate. Therefore, even in the case of using the recycled raw material, the quality of the heat shrinkable film is high.

A heat shrinkable film according to a twelfth aspect of the present invention is the heat shrinkable film according to the eleventh aspect, wherein the recycled raw material for the core layer includes a first recycled raw material and a second recycled raw material that is different from the first recycled raw material.

According to the above-described heat shrinkable film, a laminated film including a layer configured by the first recycled raw material and a layer configured by the second recycled raw material, in other words, a laminated film including different raw materials, can be used as the recycled raw material for the core layer.

A heat shrinkable film according to a thirteenth aspect of the present invention is the heat shrinkable film according to the twelfth aspect, wherein the first recycled raw material is the same raw material as the virgin raw material for the core layer.

According to the above-described heat shrinkable film, the quality can be further improved.

A heat shrinkable film according to a fourteenth aspect of the present invention is the heat shrinkable film according to the thirteenth aspect, wherein the proportion of the second recycled raw material to the recycled raw material for the core layer is equal to or less than 25 wt %.

According to the above-described heat shrinkable film, the quality can be further improved.

A heat shrinkable film according to a fifteenth aspect of the present invention is the heat shrinkable film according to any one of the eleventh to fourteenth aspects, wherein the proportion of the recycled raw material in the core layer is not less than 2.5 wt % and not greater than 80 wt %.

According to the above-described heat shrinkable film, since the proportion of the recycled raw material in the core layer is within the above-described range, the impact strength is high.

A heat shrinkable film according to a sixteenth aspect of the present invention includes: a core layer including a virgin raw material; and a surface layer layered on at least one surface of the core layer and including a virgin raw material that is different from the virgin raw material for the core layer, and a recycled raw material, wherein a proportion of the recycled raw material in the surface layer is equal to or less than 25 wt %.

According to the above-described heat shrinkable film, since the surface of the core layer is covered with the surface layer in which the proportion of the recycled raw material is low, optical properties and the like are unlikely to deteriorate. Therefore, even in the case of using a recycled raw material, the quality of the heat shrinkable film is high.

A heat shrinkable film according to a seventeenth aspect of the present invention is the heat shrinkable film according to the sixteenth aspect, wherein the recycled raw material for the surface layer includes a third recycled raw material and a fourth recycled raw material that is different from the third recycled raw material.

According to the above-described heat shrinkable film, a laminated film including a layer configured by the third recycled raw material and a layer configured by the fourth recycled raw material, in other words, a laminated film including different raw material, can be used as the recycled raw material for the surface layer.

A heat shrinkable film according to an eighteenth aspect of the present invention is the heat shrinkable film according to the seventeenth aspect, wherein the third recycled raw material is the same raw material as the virgin raw material for the surface layer.

According to the above-described heat shrinkable film, the quality can be further improved.

A heat shrinkable film according to a nineteenth aspect of the present invention is the heat shrinkable film according to the eighteenth aspect, wherein a proportion of the fourth recycled raw material to the recycled raw material for the surface layer is equal to or less than 15 wt %.

According to the above-described heat shrinkable film, the quality can be further improved.

### Advantageous Effects of Invention

According to the present invention, it is possible to provide high-quality heat shrinkable films even when a recycled raw material is used.

### BRIEF DESCRIPTION OF DRAWINGS

FIG. 1 is a cross-sectional diagram illustrating a heat shrinkable film of a first embodiment.

FIG. 2 is a cross-sectional diagram illustrating a heat shrinkable film according to a second embodiment.

FIG. 3 is a flowchart illustrating an example of a heat shrinkable film manufacturing method.

### DESCRIPTION OF EMBODIMENTS

Hereinafter, a heat shrinkable film according to an embodiment of the present invention will be described with reference to attached drawings, and then a manufacturing method for a heat shrinkable film according to an embodiment will be described.

### 1. First Embodiment

### <1-1. Configuration of Heat Shrinkable Film>

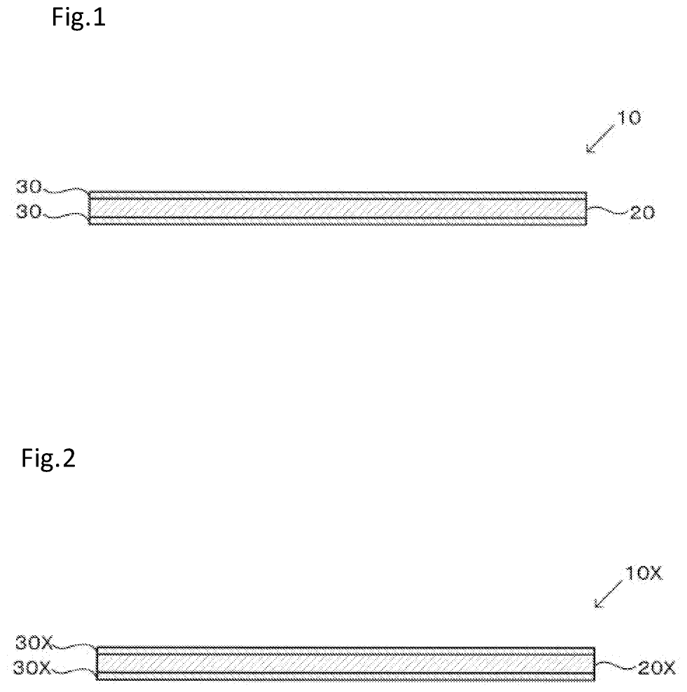

FIG. 1 is a cross-sectional diagram illustrating an exemplary layer configuration of a heat shrinkable film 10 of the first embodiment. The heat shrinkable film 10 of the present embodiment is used as a base film of a heat shrinkable film label that is attached to a container such as a plastic bottle or a metal can, for example. The heat shrinkable film 10 includes a core layer 20 and surface layers 30 layered on the core layer 20. The core layer 20 of the heat shrinkable film 10 of the present embodiment is configured so as to include a recycled raw material that is a raw material different from a virgin raw material. In general, when a recycled raw material that is different from a virgin raw material is used for heat shrinkable films, film surfaces tend to be roughened and glossiness, printing characteristics, or the like tend to deteriorate. The heat shrinkable film 10 of the present embodiment is configured in such a manner that, even when the core layer 20 is configured to include a recycled raw material that is a raw material different from a virgin raw material, the film surfaces are less likely to be roughened while high quality is maintained.

For example, the overall thickness of the heat shrinkable film 10 is preferably equal to or greater than 10 μm, more preferably equal to or greater than 12 μm, and further preferably equal to or greater than 15 μm, and is preferably equal to or less than 70 μm, more preferably equal to or less than 65 μm, and further preferably equal to or less than 60 μm. That is, the overall thickness of the heat shrinkable film 10 is preferably not less than 10 μm and not greater than 70 μm, more preferably not less than 12 μm and not greater than 65 μm, and further preferably not less than 15 μm and not greater than 60 μm. When the overall thickness of the heat shrinkable film is within the above-described range, excellent heat shrinkable properties, excellent converting properties such as printing and center sealing, or excellent properties for attaching to a container can be obtained.

### <1-2. Core Layer>

The core layer 20 includes a virgin raw material (first virgin raw material) and a recycled raw material. For the virgin raw material for the core layer 20, a known thermoplastic resin can be appropriately selected and used. Examples of the virgin raw material for the core layer 20 include polyamide-based resin, polyester-based resin, polyethylene-based resin, polyvinyl alcohol resin, polypropylene-based resin, polystyrene-based resin, cyclic olefin-based resin, and petroleum-based resin. From the viewpoint of heat shrinkable properties, the virgin raw material for the core layer 20 is preferably polystyrene-based resin, polyester-based resin, petroleum-based resin, or polypropylene-based resin, and is more preferably a combination of petroleum-based resin and polypropylene-based resin, or polystyrene-based resin alone.

### [Polystyrene-Based Resin and Polyester-Based Resin]

From the viewpoint of exhibiting heat shrinkable properties, styrene-butadiene copolymer, styrene-isoprene copolymer, styrene-isoprene-butadiene copolymer, or styrene-acrylic copolymer can be used as the polystyrene-based resin, for example. A resin obtainable by polycondensation of dicarboxylic acid components and diol components can be used as the polyester-based resin, for example.

### [Polypropylene-Based Resin]

From the viewpoint of exhibiting heat shrinkable properties, random bipolymers or random terpolymers that include propylene as main components and α-olefin as copolymerization components are preferable for the polypropylene-based resin, for example. The proportion of α-olefin being the copolymerization components is preferably 1 to 10 mol %. Further, the propylene-based resin may be a mixture of different propylene-α-olefin random copolymers. Although not particularly limited, examples of the α-olefin include ethylene, 1-butene, 1-pentene, 1-hexene, 4-methyl-1-pentene, and 1-octene. Two or more types of α-olefins may be included. The polypropylene-based resin may include long-chain branched polypropylene, propylene-based elastomer, or the like.

### [Petroleum-Based Resin]

The petroleum-based resin is a resin obtained by polymerization of C4 to C5 fraction (mainly C5 fraction), C5 to C9 fraction (mainly C9 fraction), or a mixture thereof remaining after removing ethylene, propylene, butadiene, or the like through thermal decomposition of naphtha. Examples of the petroleum-based resin include cycloaliphatic petroleum resin from cyclopentadiene or its dimer, and aromatic petroleum resin from C9 components, for example. From the viewpoint of suppressing softening of the heat shrinkable film 10 in a temperature range not higher than 100° C., or ensuring transparency and rigidity thereof, hydrogenated alicyclic petroleum resins having alicyclic structures partly or completely hydrogenated are preferable. Further, products that can be obtained through purification and polymerization of single or plural components in the C5 fraction or the C9 fraction can also be used. Further, at least part of the petroleum-based resin may be substituted with terpene resin, rosin resin, or the like. Examples of the terpene resin include terpene resin from α-pinene or ß-pinene, copolymer of α-pinene and β-pinene, aromatic-modified terpene resin, terpene phenol resin, and hydrogenated terpene resin. Examples of the rosin resin include gum rosin, wood rosin, tall oil rosin, esterified rosin modified with glycerin, pentaerythritol, or the like, and hydrogenated rosin resin.

Examples of the recycled raw material for the core layer 20 include one or more thermoplastic resins recovered from the followings: packaging materials including film labels having print layers recovered from the market, which have been subjected to deinking treatment: film labels that have been downgraded during printing processes and subjected to deinking treatment; and scrap materials generated during film manufacturing processes including manufactured selvedges, slit selvedges, and non-standard products, so on. Further, one or more thermoplastic resins recovered from resin compositions that have not been formed into films, such as lumps and strand waste of resin compositions generated in molding devices during film manufacturing processes, may be included. Hereinafter, deinked materials, scrap materials, and resin compositions generated in the above-described film label manufacturing processes will be collectively referred to as “manufacturing intermediate materials”. The recycled raw material for the core layer 20 of the present embodiment includes first recycled raw material of first thermoplastic resin and second recycled raw material of second thermoplastic resin different from the first thermoplastic resin. In the present embodiment, the difference in thermoplastic resins is not limited to the difference in type between thermoplastic resins, and includes differences in Vicat softening temperature, glass transition point, copolymer composition, weight-average molecular weight, and the like of the thermoplastic resin, even in the case of no difference in type. From the viewpoint of further improving the quality of the heat shrinkable film 10, the first recycled raw material is preferably recycled raw material of the same thermoplastic resin as the thermoplastic resin of the virgin raw material for the core layer 20. That is, a combination of petroleum-based resin and polypropylene-based resin, or polystyrene-based resin alone, is preferable as the first recycled raw material. As described above, when the first recycled raw material and the first virgin raw material are the same type of thermoplastic resin, the first thermoplastic resin may be single thermoplastic resin, or may be combined two or more different types of thermoplastic resins.

Proportion RX of the recycled raw material in the entire thermoplastic resin of the core layer 20 is arbitrarily selectable. From the viewpoint of enhancing the impact strength, the proportion RX is preferably in a range not less than 2.5 wt % and not greater than 80 wt %, and more preferably in a range not less than 3 wt % and not greater than 25 wt %.

Proportion RA of the second recycled raw material in the recycled raw material (first recycled raw material+second recycled raw material) in the entire thermoplastic resin of the core layer 20 is arbitrarily selectable. When the first recycled raw material is the same raw material as the virgin raw material for the core layer 20, from the viewpoint of improving the quality of the heat shrinkable film 10, the proportion RA is preferably equal to or less than 25 wt %, more preferably equal to or less than 15 wt %, and further preferably equal to or less than 10 wt %.

For example, the thickness of the core layer 20 is preferably not less than 5 μm and not greater than 50 μm, and more preferably not less than 7 μm and not greater than 40 μm.

### <1-3. Surface Layer>

The surface layer 30 is layered on at least one surface of the core layer 20 via an adhesive layer, for example. In the present embodiment, the surface layer 30 is layered on both surfaces of the core layer 20. The surface layer 30 may be layered on only one surface of the core layer 20.

The surface layer 30 is substantially configured solely by a virgin raw material (second virgin raw material) of a thermoplastic resin that is different from the virgin raw material (first virgin raw material) of the core layer 20. For example, the virgin raw material for the surface layer 30 is arbitrarily selectable from thermoplastic resins exemplified as the virgin raw material for the core layer 20. Among them, polyethylene-based resin, cyclic olefin-based resin, and the above-described polyester-based resin are preferable, and a combination of polyethylene-based resin and cyclic olefin-based resin or polyester-based resin alone is more preferable. It should be noted that “substantially configured solely by the virgin raw material that is different from the virgin raw material for the core layer 20” means that the surface layer 30 includes recycled raw material in addition to the virgin raw material to the extent that surface roughness does not substantially occur. In other words, the surface layer 30 includes the virgin raw material different from the virgin raw material for the core layer 20 as a main component. When the surface layer 30 includes the recycled raw material, the recycled raw material for the surface layer 30 is preferably the same raw material as the virgin raw material for the surface layer 30. There may be two or more types of recycled raw materials included in the surface layer 30 and two or more types of virgin raw materials substantially configuring the surface layer 30.

### [Polyethylene-Based Resin]

Examples of the polyethylene-based resin include linear low-density polyethylene, branched low-density polyethylene, ethylene vinyl acetate copolymer, ionomer resin, or mixture thereof. Further, copolymers of ethylene and α-olefin may also be examples of ethylene-based resins. Examples of the α-olefin include α-olefins having 3 to 20 carbon atoms, such as propylene, 1-butene, 3-methyl-1-butene, 3-methyl-1-pentene, 4-methyl-1-pentene, 1-pentene, 1-hexene, 1-heptene, 1-octene, 1-decene, 1-tetradecene, 1-hexadecene, 1-oktadecene, 1-eicosen, and the like. The proportion of α-olefin being the copolymerization components is preferably 1 to 25 mol %. Further, the ethylene-based resin may be a mixture of different ethylene-α-olefin random copolymers. The copolymer mainly including ethylene may be a random copolymer or may be a block copolymer.

### [Cyclic Olefin-Based Resin]

The cyclic olefin-based resin reduces the crystallinity of heat shrinkable films and increases the heat shrinkage rate, and can also improve the strechability during manufacturing. For example, examples of the cyclic olefin-based resin include: (a) random copolymers of ethylene or propylene and cyclic olefin: (b) ring-opened polymers of the cyclic olefin or copolymers with α-olefin: (c) hydrogenated products of the polymers described above in (b); and (d) graft modified products of (a) to (c) with unsaturated carboxylic acids and derivatives thereof.

Although not particularly limited, examples of the cyclic olefin include norbomenes and derivatives thereof, such as 6-methylnorbomene, 6-ethylnorbomene, 5-propylnorbornene, 6-n-butylnorbornene, 1-methylnorbomene, 7-methylnorbornene, 5,6-dimethylnorbomene, 5-phenyl norbomene, and 5-benzil norbomene. Further, tetracyclododecene, 8-methyltetracyclo-3-dodecen, 8-echeltetraciclo-3-dodecen, 5,10-dimethyltetracyclo-3-dodecen or the like, tetracyclododecene and its derivative are included as examples thereof. The α-olefin is as described above.

For example, the thickness of the surface layer 30 is preferably not less than 1 μm and not greater than 30 μm, more preferably not less than 2 μm and not greater than 20 μm, and further preferably not less than 3 μm and not greater than 10 μm.

The surface layer 30 may include an anti-blocking agent to exhibit anti-blocking performance. Either organic fine particles or inorganic fine particles can be used as the anti-blocking agent (anti-blocking fine particles). Organic fine particles such as acrylic resin fine particles, styrene-based resin fine particles, styrene-acrylic resin fine particles, urethane-based resin fine particles, silicone-based resin fine particles, and the like can be used as the organic fine particles. These may be crosslinked or may not be crosslinked, but being crosslinked is desirable to improve heat-resisting properties of the fine particles. Among them, acrylic resin fine particles are preferable from the viewpoint of compatibility with the above-described styrene-based resin, and polymethyl methacrylate-based crosslinked fine particles are more preferable. Further, among the above-described organic fine particles, commercially available products include, for example, TECHPOLYMER (manufactured by Sekisui Kasei Co., Ltd.), FINE SPHERE (manufactured by Nippon Paint Co., Ltd.), GANTZ PEARL (manufactured by Aica Kogyo Company, Limited), ART PEARL (manufactured by Negami Chemical Industrial Co., Ltd.) and the like.

### <1-4. Functions and Effects of Heat Shrinkable Film>

According to the heat shrinkable film 10, the surface of the core layer 20 including the recycled raw material is covered with the surface layer 30 substantially configured solely by the virgin raw material (in other words, the second virgin raw material is a main component). Therefore, optical properties and the like are unlikely to deteriorate. Accordingly, even in the case of the core layer 20 using the recycled raw material that is different from the virgin raw material, the quality of the heat shrinkable film 10 is high.

Further, since the recycled raw material for the core layer 20 includes the first recycled raw material and the second recycled raw material different from the first recycled raw material, a laminated film including a layer configured by the first recycled raw material and a layer configured by the second recycled raw material, in other words, a laminated film including different raw materials, can be used as the recycled raw material for the core layer 20. Especially, when the first recycled raw material and the first virgin raw material are a combination of petroleum-based resin and polypropylene-based resin, and the second recycled raw material and the second virgin raw material are a combination of polyethylene-based resin and cyclic olefin-based resin, natural shrinkage of the heat shrinkable film 10 can be suppressed while maintaining qualities such as heat shrinkage rate and surface properties. Further, when the core layer 20 includes a recycled material, the compressive strength can be improved.

### 2. Second Embodiment

A heat shrinkable film 10X of a second embodiment includes a core layer 20X and a surface layer 30X. The second embodiment is different from the first embodiment in this point, but is similar to the first embodiment in the rest of configuration. Hereinafter, the heat shrinkable film 10X of the second embodiment will be described mainly with respect to differences in features from the first embodiment.

### <2-1. Configuration of Heat Shrinkable Film>

FIG. 2 is a cross-sectional diagram illustrating an exemplary layer configuration of the heat shrinkable film 10× of the second embodiment. The heat shrinkable film 10× includes the core layer 20× and the surface layer 30× layered on at least one surface of the core layer 20×. When a recycled raw material is included in surface layers of heat shrinkable films, film surfaces may be roughened, and glossiness and printing characteristics or the like may deteriorate. The heat shrinkable film 10× of the present embodiment is configured in such a manner that, even when the surface layer 30× is configured to include a recycled raw material, the film surfaces are less likely to be roughened while high quality is maintained.

### <2-2. Configuration of Core Layer>

In the present embodiment, the core layer 20× is substantially configured solely by a virgin raw material (first virgin raw material) (in other words, the first virgin raw material is a main component). For example, an arbitrary thermoplastic resin exemplified for the core layer 20 of the heat shrinkable film 10 in the first embodiment can be used for the virgin raw material for the core layer 20×.

### <2-3. Configuration of Surface Layer>

The surface layer 30× includes a virgin raw material (second virgin raw material) and a recycled raw material. The virgin raw material for the surface layer 30× is different from the virgin raw material for the core layer 20×. An arbitrary thermoplastic resin exemplified for the surface layer 30 of the heat shrinkable film 10 in the first embodiment can be used as the virgin raw material for the surface layer 30×. In the present embodiment, the virgin raw material for the surface layer 30× is polyester-based resin.

The recycled raw material for the surface layer 30× of the second embodiment includes third recycled raw material of third thermoplastic resin and fourth recycled raw material of fourth thermoplastic resin that is different from the third thermoplastic resin. Here, the content of differences between thermoplastic resins is the same as defined in the first embodiment. From the viewpoint of further improving the quality of the heat shrinkable film 10×, the third recycled raw material is preferably the same raw material as the virgin raw material for the surface layer 30×. In the present embodiment, the third recycled raw material is polyester-based resin and the fourth recycled raw material is polystyrene-based resin.

Proportion RY of the recycled raw material to the entire thermoplastic resin of the surface layer 30× is equal to or less than 25 wt %, from the viewpoint of suppressing the occurrence of surface roughness in the surface layer 30×.

Proportion RB of the fourth recycled raw material to the recycled raw material (third recycled raw material+fourth recycled raw material) in the entire thermoplastic resin of the surface layer 30× is arbitrarily selectable. When the third recycled raw material is the same raw materials as the virgin raw material for the surface layer 30×, from the viewpoint of improving the quality of the heat shrinkable film 10×, the proportion RB is preferably equal to or less than 15 wt %.

### <2-4. Functions and Effects of Heat Shrinkable Film>

According to the heat shrinkable film 10×, since the surface of the core layer 20× is covered with the surface layer 30× whose proportion RY is low, optical properties and the like are unlikely to deteriorate. Therefore, even in the case of using the recycled raw material, the quality of the heat shrinkable film 10× is high.

Further, since the recycled raw material for the surface layer 30× includes the third recycled raw material and the fourth recycled raw material that is different from the third recycled raw material, a laminated film including a layer configured by the third recycled raw material and a layer configured by the fourth recycled raw material, in other words, a laminated film including different raw materials, can be used as the recycled raw material for the surface layer 30×.

### <3. Heat Shrinkable Film Manufacturing Method>

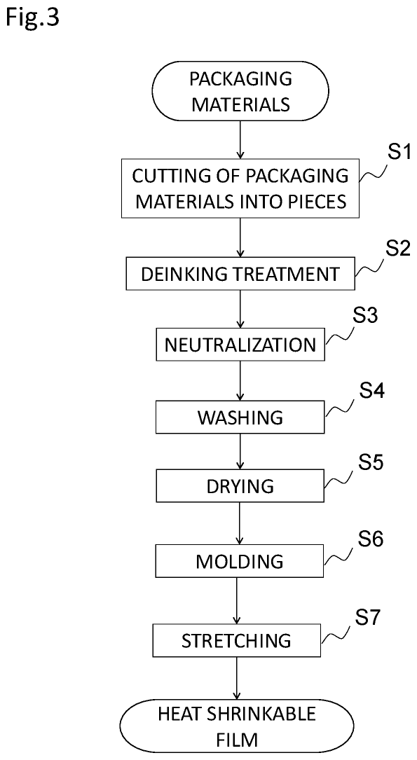

FIG. 3 is a flowchart illustrating the flow of a method for manufacturing the heat shrinkable film 10 using the packaging materials as a starting material. Hereinafter, the method for manufacturing the heat shrinkable film 10 will be described with reference to FIG. 3.

First, packaging materials serving as the starting material for manufacturing the heat shrinkable film 10 are prepared. The packaging materials include a plurality of film labels mainly recovered from the market. Each of the plurality of film labels has a resin layer including thermoplastic resin as a main component and a print layer configured by inks layered on the resin layer. The resin layers of the film labels of the present embodiment include at least the first thermoplastic resin and the second thermoplastic resin. The film labels may include the first thermoplastic resin and the second thermoplastic resin mixed in one resin layer. In addition, at least some film labels may have overcoat layers configured by an overcoat agent. Further, the film labels may be heat shrinkable or not heat shrinkable. The packaging materials may include, in addition to these film labels, other packaging materials not having print layers, such as films mainly including the first thermoplastic resin, the second thermoplastic resin, and mixture resins thereof. Preferably, the first thermoplastic resin is a combination of polypropylene-based resin and petroleum-based resin, and the second thermoplastic resin is a combination of cyclic olefin-based resin and polyethylene-based resin. Alternatively, preferably, the first thermoplastic resin is polystyrene-based resin, and the second thermoplastic resin is polyester-based resin. Further, a virgin raw material (first virgin raw material) for the first thermoplastic resin and a virgin raw material (second virgin raw material) for the second thermoplastic resin are separately prepared.

Subsequently, each of the above-described packaging materials is cut into chips as individual pieces (step S1). Methods for cutting the packaging materials are not particularly limited, and can be performed using a known slitter, shredder, pulverizer, cutting machine, or the like. Individual pieces of the packaging materials thus obtained are also referred to as fluff. Although the fluff is not particularly limited in size, it is preferably in a size that can be supplied to an extruder.

Subsequently, deinking treatment is performed to separate the print layer from the resin layer of the above-described fluff, thereby obtaining pieces of the resin layer from which the print layer has been removed (hereinafter, also referred to as “deinked fluff”) (step S2). Deinking treatment methods are not particularly limited, and a known method can be used. More specifically, as disclosed in Japanese Patent Application Laid-Open No. 11-333952 or the like, a method for removing the print layer by immersing the fluff into an alkaline aqueous solution can be used. Here, the overcoat layer is also separated from the resin layer to some extent and is removed from the resin layer.

The first thermoplastic resin and the second thermoplastic resin are included in the deinked fluff obtained in step S2. Further, a trace amount of acrylic acid (methacrylic acid) ester-based resin derived from the overcoat agent may remain in the above-described deinked fluff.

Subsequently, the deinked fluff obtained in step S2 is immersed in an acid aqueous solution to neutralize the alkalinity (step S3). Although the acid aqueous solution is not particularly limited, acetic acid aqueous solution can be used, for example. When the alkaline aqueous solution is used in step S2, providing this step S3 makes it possible to save the amount of water used in a washing process described below.

Subsequently, the deinked fluff is washed with water to wash away at least either the alkaline aqueous solution or the acid aqueous solution adhering to the deinked fluff (step S4).

Subsequently, the washed deinked fluff is dried to remove the water remaining (step S5). This can suppress thermal decomposition and deterioration of the thermoplastic resin when the deinked fluff is fed to an extruder for melt kneading or when re-pellets are manufactured from the deinked fluff. The drying method is not particularly limited, and a hot air dryer, a vacuum dryer, and a blower can be used to perform the drying. The drying temperature is preferably not higher than a temperature at which the thermoplastic resin included in the deinked fluff does not weld.

Subsequently, the deinked fluff obtained in step S5 (that is, the first recycled raw material of the first thermoplastic resin and the second recycled raw material of the second thermoplastic resin) and the first virgin raw material are included in the raw material for the core layer 20, and then a resin-based film including the core layer 20 and the surface layer 30 is molded (step S6). More specifically, the deinked fluff obtained in step S5 and other raw materials are fed to the extruder, melted and kneaded, and a resin-based film in which at least the core layer 20 and the surface layer 30 are layered is extruded. The extrusion molding may be coextrusion of the core layer 20 and the surface layer 30. In the present embodiment, the coextrusion is performed so that respective surface layers 30 are layered on both surfaces of the core layer 20. Further, the coextrusion may be performed such that adhesive layers are layered between the core layer 20 and the surface layer 30.

The core layer 20 is formed in step S6 using, as raw materials, the above-described first virgin raw material, the first recycled raw material of the first thermoplastic resin, and the second thermoplastic resin serving as the second recycled raw material. Further, the core layer 20 may be formed with a recycled raw material including a raw material other than the packaging materials used as the starting material, such as the above-described manufacturing intermediate materials. That is, step S6 may include forming the core layer 20 that further includes recycled raw material of the first thermoplastic resin or the second thermoplastic resin derived from raw materials other than the starting material.

Step S6 further includes forming the surface layer 30 including the above-described second virgin raw material as a main component. In the present embodiment, the surface layer 30 is formed so that 100% of the thermoplastic resin configuring the surface layer 30 is the virgin raw material of the second thermoplastic resin.

Subsequently, the resin-based film formed in step S6 is cooled and solidified while being wound up with a take-up roll, and then stretched uniaxially or biaxially. Thus, the heat shrinkable film 10 is obtained (step S7).

### 4. Example

### <4-1. Overview>

The inventor(s) of the present application manufactured heat shrinkable films of practical examples, a heat shrinkable film of comparative example, and a heat shrinkable film of reference example 1, and carried out tests for measuring physical properties of the heat shrinkable films. Table 1 is a table illustrating specifications about heat shrinkable films of practical examples 1 to 9, heat shrinkable film of comparative example, and heat shrinkable film of reference example 1. The heat shrinkable film of comparative example has no surface layer. The heat shrinkable film of reference example 1 has surface layers and a core layer configured solely by a virgin raw material. The practical examples 1 to 7 relate to the heat shrinkable film 10 of the first embodiment. The practical examples 8 and 9 relate to the heat shrinkable film 10× of the second embodiment. Heat shrinkable films of practical examples 1 to 9 have respective surface layers layered on both surfaces of the core layer. These heat shrinkable films include at least either polystyrene-based resin or polyester-based resin as a main component. Further, Table 2 is a table illustrating specifications about heat shrinkable films of practical examples 10 to 12, and a heat shrinkable film of reference example 2. These heat shrinkable films have respective surface layers layered on both surfaces of the core layer. The main component thereof is olefin-based resin (polyolefin-based resin, cyclic olefin-based resin, and petroleum-based resin), and the specific gravity is less than 1.

### <4-2. Virgin Material>

Specifications of virgin raw materials used for the heat shrinkable films of practical examples, comparative example, and reference examples are as follows.

### <4-2-1. Polyester-Based Resin>

The virgin raw material of the polyester-based resin includes 100 mol % of a component derived from terephthalic acid as dicarboxylic acid components, 65 mol % of a component derived from ethylene glycol, 20 mol % of a component derived from diethylene glycol, and 15 mol % of a component derived from 1,4-cyclohexanedimethanol, as diol components. The glass transition temperature thereof is 70° C.

### <4-2-2. Polystyrene-Based Resin>

The virgin raw material of the polystyrene-based resin is styrene-butadiene copolymer. The styrene-butadiene copolymer includes a styrene content by 81.3 wt % and a butadiene content by 18.7 wt %, and Vicat softening temperature thereof is 80° C.

### <4-2-3. Polypropylene-Based Resin>

The virgin raw material of the polypropylene-based resin is random copolymer that includes propylene as a main component and α-olefin as copolymerization components. The density thereof is 0.9 kg/m3, melt flow rate (MFR) thereof at 230° C. is 5.5 g/10 min, Vicat softening temperature thereof is 111° C., and melting point thereof is 132° C.

### <4-2-4. Polyethylene-Based Resin>

The virgin raw material of the polyethylene-based resin is metallocene-based low-density polyethylene that includes ethylene as a main component and α-olefin as copolymerization components. The density thereof is 0.915 kg/m3, MFR based on JIS K7210 is 1.0 g/10 min, Vicat softening temperature thereof is 98° C., and the melting point thereof is 118° C.

### <4-2-5. Petroleum-Based Resin>

The virgin raw material of the petroleum-based resin is hydrogenated alicyclic petroleum resin that is used as an adhesive or a plastic modifier and has a completely hydrogenated alicyclic structure. The density thereof is 0.98 kg/m3, and Vicat softening temperature thereof is 125° C.

### <4-2-6. Cyclic Olefin-Based Resin>

The virgin raw material of the cyclic olefin-based resin is high purity cyclic olefin copolymer. The density thereof is 1.01 kg/m3, the melt volume rate (MVR) based on ISO 1133 is 12 cm³/10 min (230° C., 2.16 kg), and the glass transition temperature thereof is 78° C.

### 4-3. Manufacturing Method of Reference Example

A method for manufacturing the heat shrinkable film of reference example 1 is as follows. First, the raw materials listed in Table 1 are used as raw materials configuring the core layer and the surface layers, and put into an extruder with a barrel temperature of 160 to 250° C., and then extruded into a 3-layered sheet from a multilayer die at 210° C. and cooled and solidified using a take-up roll at 30° C. Next, stretching is performed at a stretching ratio of 6 times in a tenter drawing machine with a preheating zone of 105° C., a stretching zone of 89 to 91° C., and a heat fixing zone of 85° C. Then, winding-up is performed with a winder, thereby obtaining a heat shrinkable film in which the direction normal to the main shrinkage direction is MD (Machine Direction) and the main shrinkage direction is TD (Transverse Direction).

Further, a method for manufacturing the heat shrinkable film of reference example 2 is as follows. First, the raw materials listed in Table 2 are used as raw materials configuring the core layer and the surface layers are used, and put into an extruder with a barrel temperature of 190 to 210° C., and then extruded into a 3-layered sheet from a multilayer die at 180° C. and cooled and solidified using a take-up roll at 30° C. Next, stretching is performed at a stretching ratio of 6 times in a tenter drawing machine with a preheating zone of 110° C., a stretching zone of 82 to 87° C., and a heat fixing zone of 82° C. Then, winding-up is performed with a winder, thereby obtaining a heat shrinkable film in which the direction normal to the main shrinkage direction is MD and the main shrinkage direction is TD.

### 4-4. Method for Manufacturing Recycled Raw Materials of Practical Examples and Comparative Example

A method for manufacturing recycled raw materials for the practical examples and the comparative example is as follows. A print layer is layered on one surface of each of the heat shrinkable films of reference examples 1 and 2, using a photogravure printing machine. Further, an overcoat layer is layered on another surface of the heat shrinkable film of reference example 2. The overcoat layer is a layer mainly including acrylic acid (methacrylic acid) ester-based resin. Next, the heat shrinkable film having the print layer is processed into chips using a pulverizer, subjected to deinking treatment, and dried with hot air, thereby manufacturing recycled raw materials for the practical examples and the comparative example.

### 4-5. Method for Manufacturing Heat Shrinkable Films of Practical Examples and Comparative Example

A method for manufacturing the heat shrinkable films of practical examples I to 9 and comparative example is as follows. The raw materials listed in Table 1 are used as raw materials configuring the core layer and the surface layers. Then, mixing of these materials is performed in the proportions shown in Table 1, thereby obtaining raw material compositions configuring the core layer and the surface layers according to the practical examples 1 to 9 and the comparative example. Using these raw material compositions, the heat shrinkable films of practical examples 1 to 9 and comparative example have been manufactured in the same manner as the heat shrinkable film of reference example 1. In the table, proportion RA indicates the proportion of polyester-based resin derived from the surface layer of the reference example to the entire thermoplastic resin configuring the core layer, and the proportion RB indicates the proportion of polystyrene-based resin derived from the core layer of the reference example to the entire thermoplastic resin configuring the surface layer.

TABLE 1

| | | Used Raw | Example | Example | Example | Example | Example | Example |
|---|---|---|---|---|---|---|---|---|
| | | Materials | 1 | 2 | 3 | 4 | 5 | 6 |
| Configuration | Surface | Virgin Raw | 100 | 100 | 100 | 100 | 100 | 100 |
| | Layer | Material | | | | | | |
| | | (Polyester- | | | | | | |
| | | Based Resin) | | | | | | |
| | | [wt %] | | | | | | |
| | | Recycled | — | — | — | — | — | — |
| | | Raw | | | | | | |
| | | Material | | | | | | |
| | | (Polyester- | | | | | | |
| | | Based Resin | | | | | | |
| | | and | | | | | | |
| | | Polystyrene- | | | | | | |
| | | Based Resin) | | | | | | |
| | | [wt %] | | | | | | |
| | Core | Virgin Raw | 95 | 90 | 80 | 65 | 50 | 35 |
| | Layer | Material | | | | | | |
| | | (Polystyrene- | | | | | | |
| | | Based Resin) | | | | | | |
| | | [wt %] | | | | | | |
| | | Recycled | 5 | 10 | 20 | 35 | 50 | 65 |
| | | Raw | | | | | | |
| | | Material | | | | | | |
| | | (Polystyrene- | | | | | | |
| | | Based Resin | | | | | | |
| | | and | | | | | | |
| | | Polyester- | | | | | | |
| | | Based Resin) | | | | | | |
| | | [wt %] | | | | | | |
| | Thickness | Surface | 5 | 5 | 5 | 5 | 5 | 5 |
| | | Layer | | | | | | |
| | | Thickness | | | | | | |
| | | (μm) | | | | | | |
| | | Core Layer | 25 | 25 | 25 | 25 | 25 | 25 |
| | | Thickness | | | | | | |
| | | (μm) | | | | | | |
| | | Surface | 5 | 5 | 5 | 5 | 5 | 5 |
| | | Layer | | | | | | |
| | | Thickness | | | | | | |
| | | (μm) | | | | | | |
| | | Total | 35 | 35 | 35 | 35 | 35 | 35 |
| | | Thickness | | | | | | |
| | | (μm) | | | | | | |
| | Proportion | Proportion | 1.7 | 3.4 | 6.8 | 11.9 | 17.0 | 22.1 |
| | | RA [wt %] | | | | | | |
| | | Proportion | — | — | — | — | — | — |
| | | RB [wt %] | | | | | | |

| | | Used Raw | Example | Example | Example | Comparative | Reference |
|---|---|---|---|---|---|---|---|
| | | Materials | 7 | 8 | 9 | Example | Example 1 |
| Configuration | Surface | Virgin Raw | 100 | 95 | 80 | — | 100 |
| | Layer | Material | | | | | |
| | | (Polyester- | | | | | |
| | | Based Resin) | | | | | |
| | | [wt %] | | | | | |
| | | Recycled | — | 5 | 20 | — | — |
| | | Raw | | | | | |
| | | Material | | | | | |
| | | (Polyester- | | | | | |
| | | Based Resin | | | | | |
| | | and | | | | | |
| | | Polystyrene- | | | | | |
| | | Based Resin) | | | | | |
| | | [wt %] | | | | | |
| | Core | Virgin Raw | 20 | 100 | 100 | 80 | 100 |
| | Layer | Material | | | | | |
| | | (Polystyrene- | | | | | |
| | | Based Resin) | | | | | |
| | | [wt %] | | | | | |
| | | Recycled | 80 | — | — | 20 | |
| | | Raw | | | | | |
| | | Material | | | | | |
| | | (Polystyrene- | | | | | |
| | | Based Resin | | | | | |
| | | and | | | | | |
| | | Polyester- | | | | | |
| | | Based Resin) | | | | | |
| | | [wt %] | | | | | |
| | Thickness | Surface | 5 | 5 | 5 | — | 4.4 |
| | | Layer | | | | | |
| | | Thickness | | | | | |
| | | (μm) | | | | | |
| | | Core Layer | 25 | 25 | 25 | 35 | 26.2 |
| | | Thickness | | | | | |
| | | (μm) | | | | | |
| | | Surface | 5 | 5 | 5 | — | 4.4 |
| | | Layer | | | | | |
| | | Thickness | | | | | |
| | | (μm) | | | | | |
| | | Total | 35 | 35 | 35 | 35 | 35 |
| | | Thickness | | | | | |
| | | (μm) | | | | | |
| | Proportion | Proportion | 27.2 | — | — | — | — |
| | | RA [wt %] | | | | | |
| | | Proportion | — | 3.3 | 13.2 | — | — |
| | | RB [wt %] | | | | | |

Further, a method for manufacturing the heat shrinkable films of practical examples 10 to 12 is as follows. The raw materials listed in Table 2 are used as raw materials configuring the core layer and the surface layers. Then, mixing of these materials is performed in the proportions shown in Table 2, thereby obtaining raw material compositions configuring the core layer and the surface layers according to the practical examples 10 to 12. In Table 2, acrylic resin content is a content rate of acrylic acid (methacrylic acid) ester-based resin derived from the overcoat layer of reference example 2 to 100 wt. % of the entire thermoplastic resin configuring each heat shrinkable film. The acrylic resin content was calculated based on the area of the signal derived from the side chain of polymethyl methacrylate in 1H-NMR spectrum obtained by NMR measurement of each heat shrinkable film. Using these raw material compositions, the heat shrinkable films of the practical example 10 to 12 have been manufactured in the same manner as the heat shrinkable film of reference example 2. In the table, proportion RA indicates the proportion of polyethylene-based resin and cyclic olefin-based resin derived from the surface layer of the reference example to the entire thermoplastic resin configuring the core layer.

TABLE 2

| | | | | | | Reference |
|---|---|---|---|---|---|---|
| | | Used Raw Materials | Example 10 | Example 11 | Example 12 | Example 2 |
| Configuration | Surface | Virgin Raw Material | 100 | 100 | 100 | 100 |
| | Layer | (Polyethylene-Based | | | | |
| | | Resin, Cyclic Olefin- | | | | |
| | | Based Resin) [wt %] | | | | |
| | | Recycled Raw Material | — | — | — | — |
| | | (Polypropylene-Based | | | | |
| | | Resin and Petroleum- | | | | |
| | | Based Resin, | | | | |
| | | Polyethylene-Based | | | | |
| | | Resin, Cyclic Olefin- | | | | |
| | | Based Resin) [wt %] | | | | |
| | Core Layer | Virgin Raw Material | 80 | 50 | 20 | 100 |
| | | (Polypropylene-Based | | | | |
| | | Resin, Petroleum-Based | | | | |
| | | Resin) [wt %] | | | | |
| | | Recycled Raw Material | 20 | 50 | 80 | — |
| | | (Polypropylene-Based | | | | |
| | | Resin and Petroleum- | | | | |
| | | Based Resin, | | | | |
| | | Polyethylene-Based | | | | |
| | | Resin, Cyclic Olefin- | | | | |
| | | Based Resin) [wt %] | | | | |
| | Thickness | Surface Layer | 5 | 5 | 5 | 5 |
| | | Thickness [μm] | | | | |
| | | Core Layer Thickness | 30 | 30 | 30 | 30 |
| | | [μm] | | | | |
| | | Surface Layer | 5 | 5 | 5 | 5 |
| | | Thickness [μm] | | | | |
| | | Total Thickness [μm] | 40 | 40 | 40 | 40 |
| | Proportion | Proportion RA [wt %] | 5.3 | 13.2 | 21.1 | — |
| | | Proportion RB [wt %] | — | — | — | — |
| | | Acrylic Resin Content | 0.2 | 0.4 | 0.5 | 0 |
| | | [wt %] (Proportion of | | | | |
| | | Overcoat Layer | | | | |
| | | Derived Acrylic Resin) | | | | |

### <5. Test>

The inventor(s) of the present application carried out tests to measure the following items on the heat shrinkable films of practical examples 1 to 12, comparative example, and reference examples 1 to 2.

### <5-1. Wet Heat Shrinkage Rate>

The heat shrinkable films obtained in the practical examples 1 to 12, comparative example, and reference examples 1 to 2 were cut into samples with a size of MD 100 mm× TD 100 mm to obtain test pieces. The obtained test pieces were immersed in hot water of 70° C., 80° C., and 90° C. and boiling water (100° C.) for 10 seconds. Then, the test pieces were taken out and immersed in water of 15° C. for 5 seconds. A heat shrinkage rate in MD direction was obtained according to the following formula (1), and a heat shrinkage rate in TD direction was obtained according to the following formula (2). In the following formula (1), LMD is the length of the test piece after heat shrinkage in the MD direction. In the following formula (2), LTD is the length of the test piece after heat shrinkage in the MD direction. The heat shrinkage rate was measured using two test pieces for the heat shrinkable films of each practical example, comparative example, and each reference example, and an average of measurement values was used.

$$\\ \begin{matrix}Heat shrinkage rate ( \% ) = \{ ( 100 - {L}_{MD} ) / 100 \} \times 100 & ( 1 )\end{matrix}$$

$$\\ \begin{matrix}Heat shrinkage rate ( \% ) = \{ ( 100 - {L}_{TD} ) / 100 \} \times 100 & ( 2 )\end{matrix}$$

### <5-2. Haze>

Haze was measured for the heat shrinkable films of practical examples 1 to 12, comparative example, and reference examples 1 to 2 using a haze meter (manufactured by Nippon Denshoku Industries Co., Ltd., NDH5000) according to a method conforming to JIS Z7136. The haze was measured using four test pieces for each practical example, comparative example, and each reference example, and an average of measurement values was calculated.

### <5-3. Glossiness>

Glossiness at incident angle 45° was measured for the heat shrinkable films of each practical example, comparative example, and each reference example using TYPE VG-2000 manufactured by Nippon Denshoku Industries Co., Ltd. according to a method conforming to JIS Z8741.

### <5-4. Impact Strength>

The heat shrinkable films of practical examples 1 to 12, comparative example, and reference examples 1 to 2 were cut into samples with a size of MD 100 mm×TD 100 mm to obtain test pieces. The obtained test pieces were measured using a film impact tester manufactured by Toyo Seiki Seisaku-sho, Ltd. according to a method conforming to JIS P8134. Specifically, the test piece is fixed on a stand. Next, a hook fixing an arm of the film impact tester is released to cause the fan-shaped arm to rotate around its axis so that an impact head attached to a distal end of the arm pierces the test piece. The impact strength is a numerical value obtainable by quantifying the energy required when the impact head pierces the test piece. Measurement of the impact strength was performed five times to obtain an average value thereof.

### <5-5. Compressive Strength>

Compressive strength was measured for the heat shrinkable films of practical examples 1 to 12, comparative example, and reference examples 1 to 2 according to a method conforming to JIS P8126. Specifically, the following method was used. The obtained heat shrinkable films were cut into strips which are 152.4 mm in length and 12.7 mm in width, and cylindrically set on a prefabricated support. Then, the support is placed on a frame of a ring crash tester (manufactured by Toyo Seiki Seisaku-sho, Ltd. TYPE D) to carry out measurement. The measurement was performed only for the compressive strength in the vertical direction (film flow direction), and an average of measurement values was obtained as n=8.

### <5-6. Young's Modulus>

The heat shrinkable films of practical examples 1 to 12, comparative example, and reference examples 1 to 2 were cut into samples with a size of MD 250 mm×TD 5 mm to obtain test pieces. The obtained test pieces were measured using STROGRAPH VE-ID manufactured by Toyo Seiki Seisaku-sho, Ltd. according to a method conforming to ASTM D882. Measurement of Young's modulus was performed using four test pieces for each practical example, comparative example, and each reference example, and an average of measurement values was calculated.

### <5-7. Surface Roughness>

The heat shrinkable films of practical examples 1 to 12, comparative example, and reference examples 1 to 2 were set in SURFCOM 570A manufactured by Tokyo Seimitsu Co., Ltd., and Ra (arithmetic mean roughness), Ramax (maximum height roughness), and Rz (ten-point average roughness) were measured in conformity to ISO13565-1 standards. Measurement conditions are as follows.
Cutoff: 0.8 mm
Driving speed of measurement terminal: 0.3 mm/see
Measurement length: 20.0 mm
Measurement magnification: vertical magnification×10,000, and horizontal magnification ×5

### <5-8. Natural Shrinkage Rate>

Three samples with a size of MD 100 mm×TD 100 mm were cut out from arbitrary portions of each of the heat shrinkable films of practical examples 10 to 12 and reference example 2. After each sample was left to stand for 7 days in a low-temperature incubator (IL-82 manufactured by Yamato Scientific Co., Ltd.) adjusted to a constant temperature, length LMD (mm) in the MD direction and length LTD (mm) in the TD direction were measured for each sample. Temperature conditions were 30° C. and 40° C. Average values of natural shrinkage rate (%) for respective samples in the MD direction and the TD direction were calculated according to the above-described formulae (1) and (2).

### <6. Test Results>

Table 3 is a table illustrating test results of the practical examples 1 to 9, comparative example, and reference example 1. The test results of the heat shrinkable films of practical examples 1 to 8 are approximately the same as those of the heat shrinkable film of reference example 1 in respective measurement items. Further, the heat shrinkable film of practical example 9 is slightly higher in haze than that of the heat shrinkable film of reference example 1 and is slightly lower in glossiness than that of the heat shrinkable film of reference example 1. However, in the remaining measurement items, test results of the heat shrinkable film of practical example 9 are approximately the same as those of the heat shrinkable film of reference example 1. In respective heat shrinkable films of practical examples 1 to 7, the surfaces of the core layers including the recycled raw materials are covered with the surface layers substantially configured solely by the virgin raw materials. In the heat shrinkable films of practical examples 8 and 9, the surfaces of the core layers are covered with the surface layers that are lower in proportion RY. Therefore, it is considered that the heat shrinkable films of the above practical examples have physical properties similar to those of the heat shrinkable film of reference example 1. On the other hand, regarding respective measurement items, the heat shrinkable film of comparative example is higher in haze than the heat shrinkable film of reference example and is lower in glossiness than the heat shrinkable film of reference example 1. Why the heat shrinkable film of comparative example is deteriorated in glossiness is believed because the core layer includes the recycled raw material that is different from the virgin raw material.

TABLE 3

| | | | | | Example | Example | Example | Example | Example | Example |
|---|---|---|---|---|---|---|---|---|---|---|
| | Item | | Condition | | 1 | 2 | 3 | 4 | 5 | 6 |
| Physical | Wet Heat | MD/TD | 70° C. | % | −4/41 | −3/41 | −3/41 | −3/39 | −2/40 | −3/39 |
| Properties | Shrinkage | | 80° C. | % | −4/60 | −4/60 | −2/60 | −3/57 | −1/61 | −3/60 |
| | Rate (10 s) | | 90° C. | % | 0/70 | 1/70 | 1/69 | 0/67 | −1/68 | 0/69 |
| | | | 100° C. | % | 7/75 | 7/75 | 8/75 | 5/74 | 6/76 | 8/75 |
| | Haze | | | % | 7.26 | 7.14 | 7.55 | 6.74 | 6.86 | 7.66 |
| | Glossiness | | | % | 172.7 | 172.9 | 172.3 | 165.6 | 165.5 | 166.5 |
| | Impact | | | J | 0.81 | 0.96 | 1.21 | 0.98 | 0.97 | 1.01 |
| | Strength | | | | | | | | | |
| | Compressive | | | N | 3.09 | 3.41 | 3.36 | 3.3 | 3.49 | 3.34 |
| | Strength | | | | | | | | | |
| | Young's | MD/TD | | Gpa | 1.4/2.6 | 1.5/2.5 | 1.5/2.9 | 1.6/3.0 | 1.6/3.0 | 1.5/3.1 |
| | Modulus | | | | | | | | | |
| | Surface | Ra | | μm | 0.10 | 0.09 | 0.10 | 0.07 | 0.08 | 0.09 |
| | Roughness | Rmax | | μm | 4.22 | 3.75 | 4.52 | 3.44 | 3.45 | 4.12 |
| | | Rz | | μm | 1.98 | 1.78 | 2.51 | 1.62 | 1.98 | 1.87 |

| | | | | | Example | Example | Example | Comparative | Reference |
|---|---|---|---|---|---|---|---|---|---|
| | Item | | Condition | | 7 | 8 | 9 | Example | Example 1 |
| Physical | Wet Heat | MD/TD | 70° C. | % | −3/35 | −4/40 | −3/38 | −3/41 | −4/41 |
| Properties | Shrinkage | | 80° C. | % | −3/60 | −4/59 | −6/58 | −4/60 | −3/60 |
| | Rate (10 s) | | 90° C. | % | −1/69 | 2/69 | 3/68 | 1/71 | 2/70 |
| | | | 100° C. | % | 8/75 | 7/75 | 7/74 | 7/76 | 5/74 |
| | Haze | | | % | 7.74 | 6.32 | 8.05 | 9.73 | 5.95 |
| | Glossiness | | | % | 165.5 | 171.4 | 149 | 110 | 173.4 |
| | Impact | | | J | 0.98 | 0.88 | 0.87 | 0.85 | 0.81 |
| | Strength | | | | | | | | |
| | Compressive | | | N | 3.3 | 3.12 | 3.05 | 2.74 | 3.11 |
| | Strength | | | | | | | | |
| | Young's | MD/TD | | Gpa | 1.6/3.3 | 1.4/25 | 1.3/2.0 | 1.2/1.8 | 1.4/2.5 |
| | Modulus | | | | | | | | |
| | Surface | Ra | | μm | 0.08 | 0.08 | 0.09 | 0.13 | 0.08 |
| | Roughness | Rmax | | μm | 3.85 | 3.88 | 3.84 | 3.59 | 4.13 |
| | | Rz | | μm | 2.14 | 2.34 | 2.20 | 2.16 | 1.82 |

Table 4 is a table illustrating test results of practical examples 10 to 12 and reference example 2. It was confirmed that the heat shrinkable film of each practical example was in a level of causing no problem in use with respect to wet heat shrinkage rate. Further, the heat shrinkable film of each practical example was better in natural shrinkage rate than the heat shrinkable film of reference example 2. This is believed because the recycled raw material, especially cyclic olefin-based resin, is included in the core layer. Further, the compressive strength was also better. In comparison with reference example 2, it was confirmed that the heat shrinkable film of each practical example is in a level of causing no problem in use, although the heat shrinkable film of each practical example was slightly inferior in both haze and glossiness. Regarding the impact strength, Young's modulus, and surface roughness, there is no substantial difference between the heat shrinkable film of each practical example and the heat shrinkable film of reference example 2. It was confirmed that the levels of these physical properties were maintained even when recycled raw materials were used.

TABLE 4

| | | | | | Example | Example | Example | Reference |
|---|---|---|---|---|---|---|---|---|
| | Item | | Condition | Units | 10 | 11 | 12 | Example 2 |
| Physical | Wet Heat Shrinkage | MD/TD | 70° C. | % | 1/14 | 1/13 | 1/11 | 1/15 |
| Properties | Rate (10 s) | | 80° C. | % | 3/37 | 3/38 | 3/37 | 4/37 |
| | | | 90° C. | % | 5/55 | 6/55 | 6/56 | 6/56 |
| | | | 100° C. | % | 10/62 | 11/64 | 11/65 | 12/62 |
| | Natural Shrinkage | MD/TD | 30° C. | % | 0.1/0.4 | 0.1/0.3 | 0.0/0.2 | 0.1/0.5 |
| | Rate (1 W) | | 40° C. | % | 0.4/2.7 | 0.3/2.5 | 0.3/2.4 | 0.4/2.8 |
| | Haze | | | % | 4.4 | 4.5 | 4.9 | 4.1 |
| | Glossiness | | | % | 144 | 140 | 137 | 145 |
| | Impact Strength | | | J | 0.36 | 0.32 | 0.38 | 0.35 |
| | Compressive | | | N | 4.6 | 4.6 | 4.7 | 4.4 |
| | Strength | | | | | | | |
| | Young's Modulus | MD/TD | | Gpa | 1.4/1.8 | 1.4/1.9 | 1.5/2.0 | 1.4/1.8 |
| | Surface Roughness | Ra | | μm | 0.12 | 0.12 | 0.1 | 0.11 |
| | | Rmax | | μm | 2.7 | 2.9 | 2.8 | 2.8 |
| | | Rz | | μm | 1.9 | 1.9 | 2 | 2 |

### 7. Modified Embodiment

Each of the above-described embodiments is an exemplary form that the heat shrinkable film according to the present invention can take, and is not intended to limit the form. The heat shrinkable film according to the present invention may take a form different from the form illustrated in each embodiment. An example thereof is a form in which a part of the configuration of each embodiment is replaced, changed, or omitted, or a form in which a new configuration is added to each embodiment. Some exemplary modifications of respective embodiments will be described below.

<7-1>

In the first embodiment, the first recycled raw material for the core layer 20 is the same raw material as the virgin raw material for the core layer 20. However, the first recycled raw material may be a raw material different from the virgin raw material for the core layer 20. That is, in this modified embodiment, the virgin raw material for the core layer 20, the first recycled raw material, and the second recycled raw material are raw materials different from each other.

<7-2>

In the first embodiment, the recycled raw material for the core layer 20 includes the first recycled raw material and the second recycled raw material. However, the recycled raw material for the core layer 20 may be only the first recycled raw material. In this modified embodiment, the first recycled raw material may be the same raw material as the virgin raw material for the core layer 20 or may be a raw material different from the virgin raw material for the core layer 20.

<7-3>

In the second embodiment, the core layer 20× substantially includes only the virgin raw material. However, like the first embodiment, the core layer 20× may include the recycled raw material.

<7-4>

In the second embodiment, the third recycled raw material for the surface layer 30× is the same raw material as the virgin raw material for the surface layer 30×. However, the third recycled raw material may be a raw material different from the virgin raw material for the surface layer 30×. That is, in this modified embodiment, the virgin raw material for the surface layer 30×, the third recycled raw material, and the fourth recycled raw material is different from each other.

<7-5>

In the second embodiment, the recycled raw material for the surface layer 30× includes the third recycled raw material and the fourth recycled raw material. However, the recycled raw material for the surface layer 30× may be only the third recycled raw material. In this modified embodiment, the third recycled raw material may be the same raw material as the virgin raw material for the surface layer 30×, or may be a raw material different from the virgin raw material for the surface layer 30×.

<7-6>

The order of steps S1 to S5 in the above-described embodiment may be changed. For example, neutralization, washing, drying, and the like may be performed, if necessary, after performing the deinking treatment for separating the print layers from the packaging materials. Subsequently, the resin layers of the packaging materials from which the print layers have been removed may be cut into pieces to obtain the deinked fluff. Further, at least one of cutting, neutralization, washing, and drying may be appropriately omitted, or may be performed two times or more if necessary. Moreover, the recycled raw material may be used in step S6 after completing a step of being pelletized, instead of in the form of fluff.

<7-7>

In step S6 of the above-described embodiment, the heat shrinkable film 10× can be manufactured by forming a resin-based film including the surface layer 30× including the deinked fluff (recycled raw material) obtained in step S5 and the second virgin raw material and the core layer 20× at least including the first virgin raw material. In this case, the surface layer 30× is formed so as to include the recycled raw material of 20 wt % or less to the entire thermoplastic resin included in the surface layer 30×. In this case, the deinked fluff may include the third recycled raw material of third thermoplastic resin and the fourth recycled raw material of fourth thermoplastic resin that is different from the third thermoplastic resin. The second virgin raw material may be the virgin raw material of third thermoplastic resin. Further, step S6 may include forming the surface layer 30× such that the proportion of the fourth recycled raw material to the recycled raw material included in the entire thermoplastic resin of the surface layer 30× is 15 wt % or less.

### REFERENCE SIGNS LIST

10, 10×: heat shrinkable film
20, 20×: core layer
30, 30×: surface layer

1. A manufacturing method for a heat shrinkable film comprising:
preparing packaging materials including a plurality of film labels having a resin layer including thermoplastic resin as a main component and a print layer;
preparing a first virgin raw material of thermoplastic resin and a second virgin raw material of thermoplastic resin that is different from the first virgin raw material;
recovering, from the resin layer, a recycled raw material of one or more thermoplastic resins; and
forming a resin-based film including the recycled raw material as a raw material so as to have a core layer and a surface layer layered on the core layer,
wherein the recovering the recycled raw material of one or more thermoplastic resins includes:
cutting at least either the packaging materials or the resin layer from which the print layer has been removed into pieces; and
separating the print layer from at least either the packaging materials or the pieces of the packaging materials, thereby obtaining at least either the resin layer from which the print layer has been removed or the pieces of the resin layer from which the print layer has been removed,
the forming the resin-based film includes at least one of:
forming the core layer including at least the recycled raw material and the first virgin raw material and the surface layer including the second virgin raw material as a main component, and
forming the core layer including at least the first virgin raw material and the surface layer including the second virgin raw material and the recycled raw material of 25 wt % or less.

2. The manufacturing method for a heat shrinkable film according to claim 1,
wherein:
the forming the resin-based film includes forming the core layer including at least the recycled raw material and the first virgin raw material and the surface layer mainly including the second virgin raw material; and
the recycled raw material includes a first recycled raw material of a first thermoplastic resin and a second recycled raw material of a second thermoplastic resin that is different from the first thermoplastic resin.

3. The manufacturing method for a heat shrinkable film according to claim 2, wherein the first virgin raw material is a virgin raw material of the first thermoplastic resin.

4. The manufacturing method for a heat shrinkable film according to claim 3, wherein the forming the resin-based film includes forming the core layer such that a proportion of the second recycled raw material to the recycled raw material in the core layer is equal to or less than 25 wt %.

5. The manufacturing method for a heat shrinkable film according to claim 1, wherein the forming the resin-based film includes forming the core layer such that a proportion of the recycled raw material in the core layer is not less than 2.5 wt % and not greater than 80 wt %.

6. The manufacturing method for a heat shrinkable film according to claim 2, wherein the first thermoplastic resin is polystyrene-based resin, and the second thermoplastic resin is polyester-based resin.

7. The manufacturing method for a heat shrinkable film according to claim 2, wherein the first thermoplastic resin is polypropylene-based resin and petroleum-based resin, and the second thermoplastic resin is polyethylene-based resin and cyclic olefin-based resin.

8. The manufacturing method for a heat shrinkable film according to claim 1, wherein:
the forming the resin-based film includes forming the core layer including at least the first virgin raw material and the surface layer including the second virgin raw material and the recycled raw material of 25 wt % or less; and
the recycled raw material includes a third recycled raw material of a third thermoplastic resin and a fourth recycled raw material of a fourth thermoplastic resin that is different from the third thermoplastic resin.

9. The manufacturing method for a heat shrinkable film according to claim 8, wherein the second virgin raw material is a virgin raw material of the third thermoplastic resin.

10. The manufacturing method for a heat shrinkable film according to claim 9, wherein the forming the resin-based film includes forming the surface layer such that a proportion of the fourth recycled raw material to the recycled raw material in the surface layer is equal to or less than 15 wt %.

11. A heat shrinkable film comprising:
a core layer including a virgin raw material and a recycled raw material; and
a surface layer layered on at least one surface of the core layer and configured solely by a virgin raw material that is substantially different from the virgin raw material for the core layer.

12. A heat shrinkable film comprising:
a core layer including a virgin raw material; and
a surface layer layered on at least one surface of the core layer and including a virgin raw material that is different from the virgin raw material for the core layer and a recycled raw material,
wherein a proportion of the recycled raw material in the surface layer is equal to or less than 25 wt %.
